(19) United States
(12) Patent Application Publication
(10) Pub. No.: US 2018/0158130 A1
(43) Pub. Date: Jun. 7, 2018

(54) System, Method and Apparatus for Enabling Commercial Transactions on Behalf of Members Joined in a Social Network

(71) Applicant: Keyhan Kaveh, Irvine, CA (US)

(72) Inventor: Keyhan Kaveh, Irvine, CA (US)

(21) Appl. No.: 15/366,997

(22) Filed: Dec. 1, 2016

(51) Int. Cl. G06Q 30/06; G06Q 50/00; G06Q 20/10

(52) U.S. Cl. CPC G06Q 30/0633; G06Q 20/10; G06Q 30/0603; G06Q 50/01

(57) ABSTRACT

An electronic wish list system, method, and apparatus are provided. In particular, the system and method enables gifting and committing commercial transactions on behalf of a recipient by presenting a variety of desired items, which may be offered by sale by disparate retailers and other sellers, to a broadly inclusive swath of the recipient's social network. The desired items may be catalogued by the recipient according to typical gift-giving occasions, easing selection process for prospective gift-givers and further centralizing the variety of potential lists a recipient may otherwise require. Even further easing the gift-giving process, a selection and ultimate purchase of the wished-for item may cause the item to be directly sent to the recipient.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to commerce enabled by electronic networking systems and, more particularly, to a system, method and apparatus configured to enable gifting among inclusive social networks.

### BACKGROUND

As electronic and web-based commerce has become more common, individual retailers with online presence have taken to providing online wish list services. That is, many retailers allow prospective shoppers including past, present and even potential clients, to select items from the store's available goods, and rather than immediately purchasing such goods, saving them to a “wish list” for later purchase. Such wish lists may be shared with friends and family by sending URLs specifically directing such friends and family to the lists via email or even text message so that such friends and family may make a particular purchase on the wisher's behalf. It is contemplated that providing wish lists may ease gift-buying for friends and family, enabling them to purchase goods explicitly desired by the prospective recipient.

Some improvements to electronic or online wish lists have been suggested. For instance, U.S. Pat. No. 7,356,490 to Jacobi et al. discloses a system which alerts an online shopper to any friends who may desire an item which the shopper is himself viewing. Thus, while considering his own purchases, he may efficiently consider purchasing an item on behalf of a friend, family member, or acquaintance who has expressed interest in the item as well.

Unfortunately, problems with online wish lists persist. For instance, many wish lists are stored on websites hosted by individual retailers. In the event that a recipient desires items from disparate providers or retailers, a prospective giver must visit, or otherwise be directed to various individual websites to view each of the wish lists. As another example, many wish lists fail to easily address or be accessed by the breadth of potential gift-givers in a recipient's network of friends, family and acquaintances. As still another example, many wish lists fail to differentiate occasions for which a recipient may desire certain gifts. This may be because many wish lists are directed to specific occasions. For instance, wedding and baby shower registries are well known in the art, however, these are limited to the aforementioned occasions and may not be appropriate for other life events such as birthdays, house warmings, charity fund raisers or the like.

Thus, there remains a need for an electronic wish list system and method that enables gifting on behalf of a recipient by presenting a variety of desired items offered by unrelated retailers to a broadly inclusive swath of the recipient's social network in light of a variety of disparate occasions.

### SUMMARY

The present disclosure is directed to means for centralizing listings of desired consumer goods which may be collected from a variety of disparate sellers and further inclusively presenting such listings to a prospective recipient's friends, family and acquaintances as may be electronically joined in a social network. In communication with a user's social network, the related system, method, and apparatus may be configured to display desired items, catalogue items according to specific gifting occasions, prompt the social network to view the desired items in advance of a particular gifting occasion, prompt payment for and delivery of a selected item, and even notify a recipient when an item has been purchased on his behalf from the centralized listing.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

Typically, social networking sites allow users to upload and share photographs and notes with friends, generate personalized newsfeeds, and monitor and interact with the activities of users' friends and request and establish connections with other users on the social networking site by becoming friends within the user's social network. Such networks include for example FACEBOOK®, INSTAGRAM®, LINKEDIN® and TWITTER®. These networks may remotely connect hundreds if not thousands of individuals and organizations. In many cases, this allows parties who are geographically or otherwise distanced from one another to remain in communication. Embodiments of the present invention take advantage of this broad connectivity and include methods, apparatuses and computer-readable media to enable gifting, donation, and recognition for a variety of special occasions among such broadly connected members.

To do so, a personal electronic or mobile device such as a smartphone, tablet, laptop, or personal computer may be used to receive recipient information. This information may correspond to the shipping address, name, age, gender and other bibliographic information of a member of a gifting network, defined as desired by one or more preexisting social networks. The gifting network in particular may comprise givers and recipients as members, though each member may be both a recipient and a giver, depending on his or her actions within the system. For instance, though each member may provide a listing of desired items, each member may electronically access each others' listing of desired items so as to provide them with a gift.

Thus, it is contemplated that each member may optionally provide for display a selection of one or more desired items in a centralized location which other members may then select for purchase on the other's behalf. Each desired item may be supplied or sold or otherwise provided by one or more third party sellers so that a member of the gifting network is not limited to particular items and commercial providers. Additionally, it is contemplated that the system and method avoid limiting members to selecting items for singular gifting occasions. That is, rather than limiting a gifting network to providing gifts for certain events, such as a baby shower or a wedding, each gifting occasion may be included with reference to the recipient member. Indeed, desired items may even be catalogued by a recipient according to a gifting occasion.

Once a decision to purchase a desired item is made by a giving member, the gift giver may be directly prompted to provide payment for the item within the user interface defined by the system. In another embodiment, however, the gift giver may be redirected upon selection of a desired item from the visual listing, to the electronic seller, dealer or other provider of such item. In any event, it is contemplated that once payment is provided, the delivery of the selected item may be prompted so that such item may be directly provided to the recipient. A recipient location, such as the recipient's shipping address, or even bank account information, as the case may be, may be optionally hidden from the recipient's social network in order to protect his or her privacy.

Along with automatic delivery, a gift giver may be prompted to provide a message or note related to the gift, the recipient, and/or the occasion for such gifting, adding elements of personalization to this efficiently enabled gifting process.

Thus, it is an object of the invention to inclusively present desired items to a broadly inclusive cross-section of a user's friends, family members, and acquaintances, including electronically based members of a social network.

It is another object of the invention to provide a wish list of items available from disparate sellers in a manner that avoids needing to affirmatively alert potential gifters of the existence of such wish list.

It is yet another object of the invention to present desired items sold by disparate retailers, wholesalers, and other suppliers in a single location.

It is still another object of the invention to enable cataloguing of disparate items according to different gift-giving occasions in a recipient's life.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for enabling commercial transactions on behalf of members joined in a social network is implemented.

FIG. 2 is a flowchart depicting an exemplary embodiment of a method for enabling commercial transactions on behalf of members joined in a social network which may be performed by the system shown in FIG. 1.

FIG. 3 illustrates an exemplary embodiment of a mobile device shown in FIG. 1.

FIG. 4 illustrates an alternative networked environment in which another exemplary embodiment of a system for enabling commercial transactions on behalf of members joined in a social network is implemented.

FIGS. 5A-C illustrate a plurality of exemplary user interfaces for the system and method for enabling commercial transactions on behalf of members joined in a social network.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

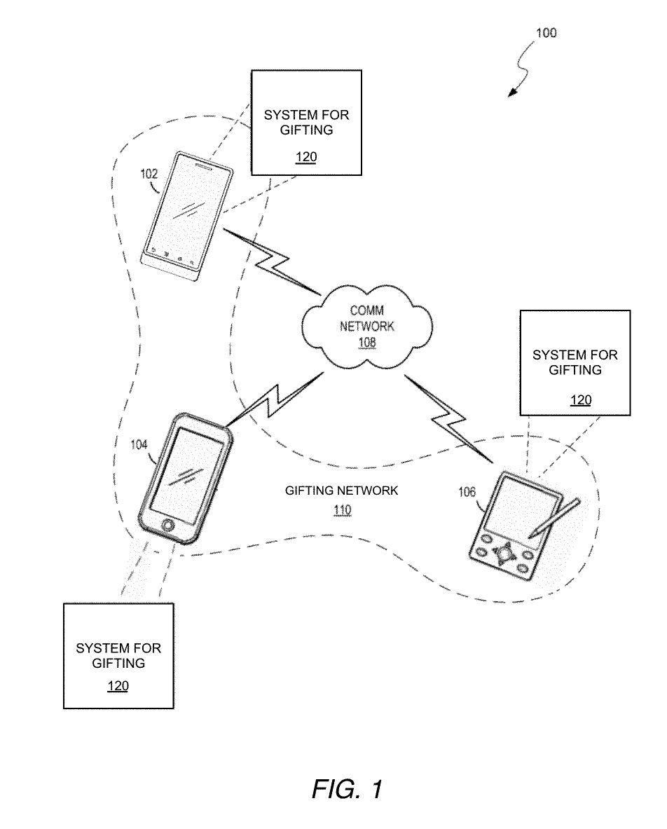

FIG. 1 illustrates an exemplary embodiment of the system 100 for enabling commercial transactions on behalf of members joined in a social network which includes a plurality of mobile devices communicatively coupled to one another. By way of example, and not limitation, FIG. 1 illustrates three mobile devices 102, 104 and 106 communicatively coupled via a communication network 108. Each of the mobile devices may be embodied as a mobile computing device such as, for example and without limitation, a smartphone or tablet computer that incorporates cellular telephone functionality. Notably, the communications network can use one or more of various communications types such as, for example and without limitation, cellular and Wi-Fi communications.

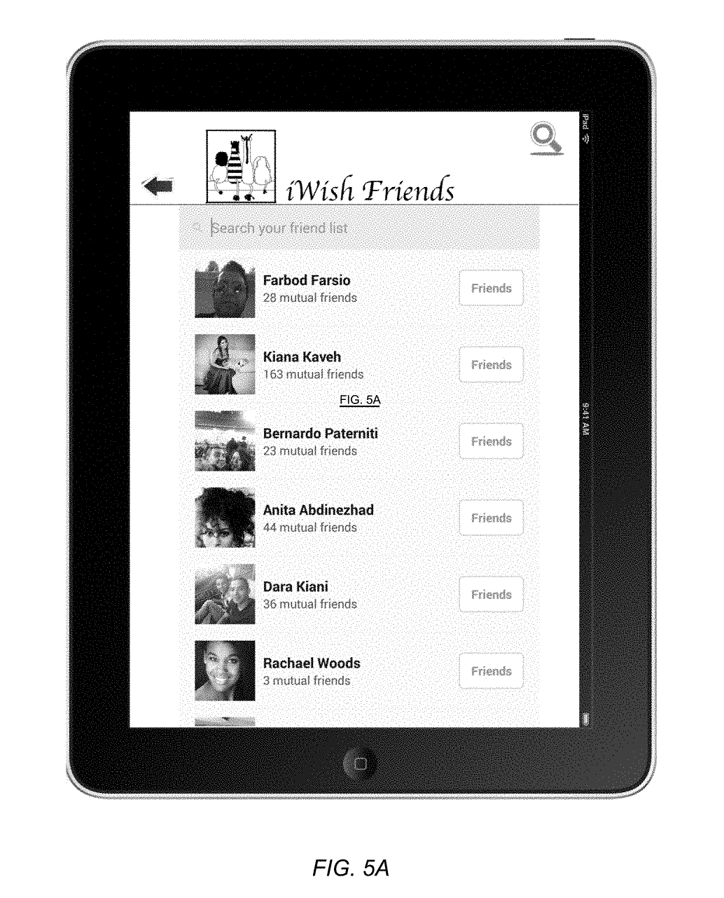

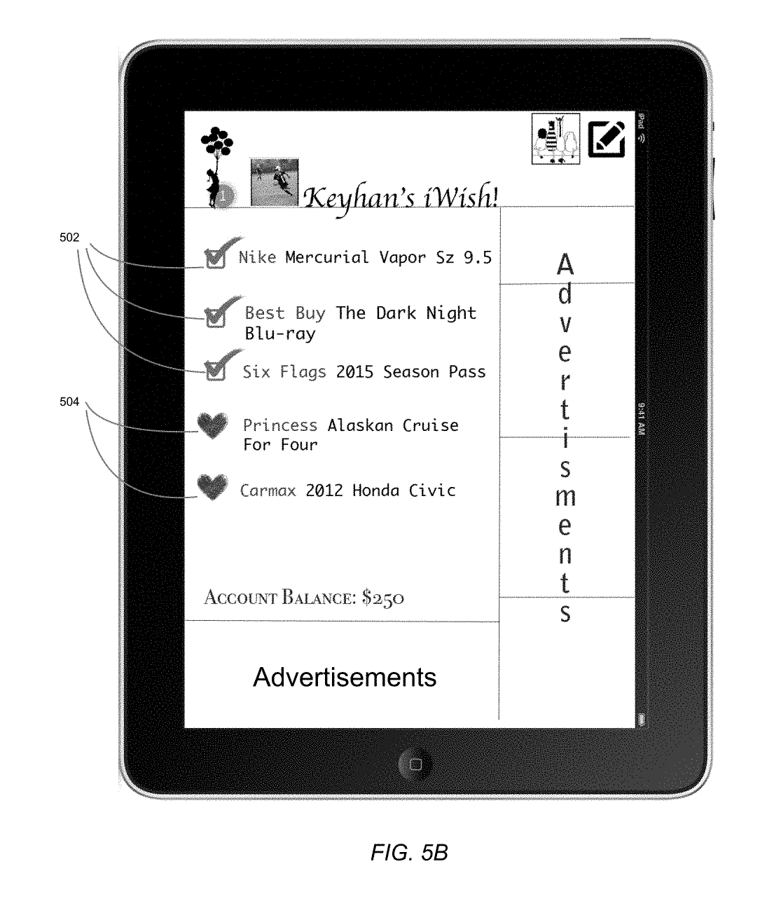

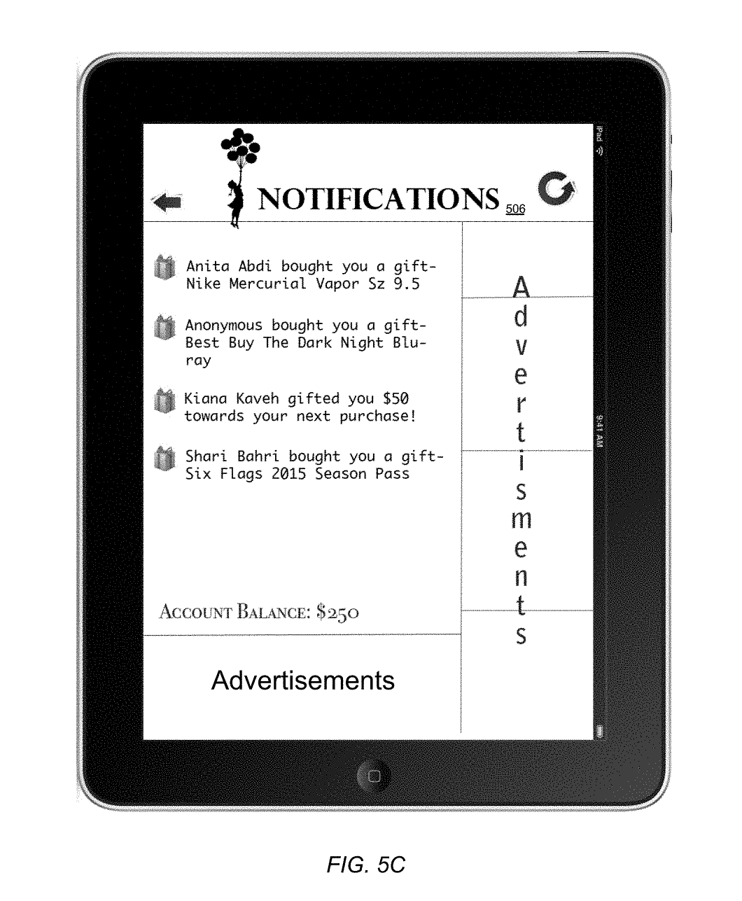

Users of mobile devices 102, 104 and 106 may be members of an inclusive and centralized gifting network 110 that is defined by connected members of existing social network(s) known to those skilled in the art. For instance, as noted above, the users of mobile devices 102, 104 and 106 may be communicatively linked via any one or a combination of FACEBOOK®, TWITTER®, LINKEDIN®, INSTAGRAM® and others. Such a gifting network 110 enables socially connected members, then, to use their devices 102, 104 and 106 to interact with each other as relates in particular to social gift-giving occasions including, for example, birthdays, holidays, anniversaries, weddings, housewarmings, going away, and baby showers, among others. In this case, the system 100 utilizes such existing social networks to enable gifting by drawing lists of prospective gifters, or generally friends, broadly from such existing networks. Such inclusive listing of friends drawn from a social network may be visualized as in the exemplary interface in FIG. 5A. This may allow members to view each others' desired items, so that depending on the action, each member may respectively be deemed recipient or gift giver. Indeed, it is contemplated that this avoids needing to affirmatively and individually inform potential gifters of the existence of the wish lists such as by sending a text or other message, including a URL for example, directing them to the lists.

Returning to FIG. 1, the gifting network 110 may be facilitated by a website that may require a registration and login prior to use. However, regardless of how such a gifting network is implemented (be it web-based or not), the functionality of concern involves the ability to provide interaction and ultimately gifting among a group of members, as may be established by the members themselves. In an embodiment, the gifting network 110 may be made public and accessible to those outside of the recipient's social network. In another embodiment, however, it is contemplated that the gifting network 110 may be accessible to only limited members of the recipient's social network, as desired by the recipient. Still, it is contemplated that the gifting network 110 operates on a principle of inclusion. That is, potential gifters, or friends, are drawn generally from the recipient's existing social networks and may later be limited access as desired.

In one embodiment, one way to add a member to the gifting network may be by the recipient using their device 102 to send an invitation to another user's device 104 inviting them to join the network 110. Sending a network invitation to another member will prompt them to enter identification information such as, by way of example, name, email address, payment credentials, and receipt location such as shipment address or bank account information. Some or all of the listed information may be hidden from view so as to protect particularly sensitive aspects of a member's privacy. Upon complying with the membership requirements, the new member, a gifter will be given access, using their mobile device 104, to various information, including for example listing of desired items and dates associated with gift-giving occasions, provided by the first member, a recipient, on their device 102.

In operation, the system 100 provides a better and more coordinated way in which a group of friends, family, acquaintances, associates, and even prospective clients and donors can gift or donate desired items and/or funds to a recipient, in order to recognize or celebrate certain occasions. Specifically, the system 100 presents items desired by a recipient to the members of the gifting network 110 and further enables such members to directly purchase and send such desired items to the recipient. The system 100 may, in particular, be instructed to visually list or otherwise display items, including money, desired by a member to enable this functionality. The items may be selected from one or more disparate online sellers, retailers, wholesalers and other suppliers and may be particularly selected to reflect a receiving member's personal size and taste. Such items may be sorted and displayed according to particular gifting occasions, as desired. Then, as a result of such purchasing by a gifting member, the recipient and other members of the gifting network 110 can be updated as to whether a desired item has been purchased for the recipient.

The system 100 may be further configured to notify members of the gifting network 110 in advance of gifting occasions, such as birthdays, which may be personal to each other member. Such notification may be designed to encourage social gifting for a variety of occasions while avoiding a need to directly inquire as to a recipient's desired gifts, which may be uncouth, or accidentally purchasing an item which may not be in line with the recipient's tastes, interests, needs or even size.

Indeed, responsive to determining that a member has selected an item on behalf of a recipient member, the system 100 may automatically transmit information or otherwise visually indicate to members of the gifting network 110 that such desired item has been purchased. This avoids duplicate gifts. In some embodiments, this information will include a graphic representation that the gift has been purchased. For instance, with reference to FIG. 5B, items which have been purchased are preceded by a check mark 502 while items which have not been purchased on the recipient's behalf are preceded by a graphic heart 504. It should also be noted that an exemplary user interface may indicate the source or seller of the desired items. Though the items are each from different sellers, (i.e. “Nike,” “Best Buy,” “Six Flags,” “Princess,” “Carmax”), the system may ensure that they are presented in a centralized list, and purchase is available directly in the gifting network.

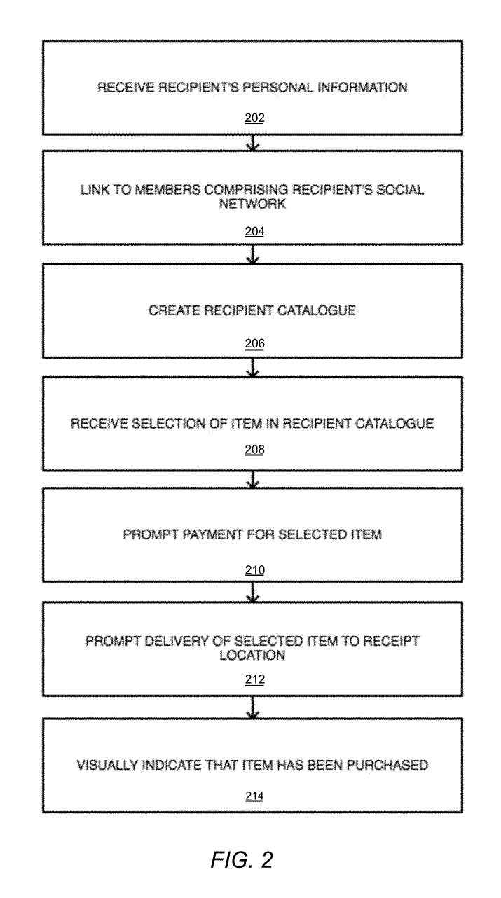

FIG. 2 is a flowchart depicting an exemplary embodiment of a system and method for enabling commercial transactions on behalf of members joined in a social network such as may be performed by mobile device 102 104, and 106 of FIG. 1. As shown in FIG. 2, the method includes the steps of: receiving a recipient's personal information (block 202); linking to members comprising the recipient's social network to define a gifting network (block 204); creating a recipient catalogue (block 206), which may include for instance, desired items offered for sale by a variety of disparate providers. Various methods for developing the recipient catalogue are contemplated. For instance, in some embodiments, a recipient may supply the system with a link to a supplier's URL associated with the desired item which may cause the item, including any specifications such as recipient's desired size and color, to be presented among other items desired by the recipient in the gifting network. In other embodiments, a link to the system may be provided by each seller so that when a recipient accesses a desired item, including any specifications such as desired size and color, from a seller's webpage, he or she may simply click on such link to automatically add the desired item to his or her wish list. Clicking such link, which may in some embodiments comprise words, logos, or other indications that such link is associated with the disclosed system, may be followed by additional prompts as needed, such as for example, prompting the recipient to log in to his wish lists and select which of any gifting occasions the recipient would like the item for. In still other embodiments, a recipient may be directed to optionally download a browser extension, known in the art, which may enable a recipient to save desired items to his or her recipient catalogue. In even still other embodiments, scanners and other digital photo-capture applications typically incorporated in smartphone functionality may be used to capture and share images of item barcodes via the system in the event that a desired item is discovered in a physical store or location or otherwise unavailable for purchase or viewing online. Thus, it should be apparent that the invention will not be limited by the particular methods or apparatuses used to create the recipient catalogue.

The desired items may additionally be sorted according to gifting occasions specific to the recipient. The method may further include the steps of: receiving a selection of an item in the recipient catalogue (block 208) from a member of the gifting network; prompting such member's payment for the selected item (block 210); prompting delivery of the selected item to a receipt location (block 212) which may have been included with the recipient's personal information; and visually indicating to members of the gifting network including the recipient that the item has been purchased (block 214). As seen in FIGS. 5B and C, this may include visual identifiers that a desired item has been purchased, as well as written notifications 506 immediately indicating which item was purchased and by whom. This may facilitate efficient thanking of the member who provided the item as well as the satisfaction of receiving a thoughtful and desired item.

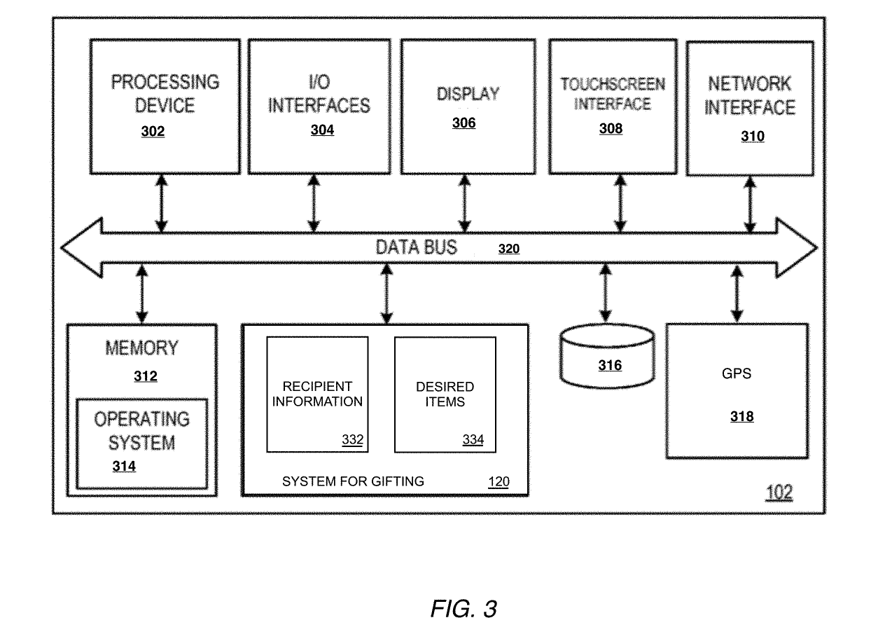

FIG. 3 illustrates mobile electronic device 102 shown in FIG. 1. As described earlier, electronic, or simply mobile, device 102 may be a tablet computer or smartphone but may also be embodied in any one of a wide variety of wired and/or wireless computing devices. As shown in FIG. 3, mobile device 102 includes a processing device (processor) 302, input/output interfaces 304, a display 306, a touchscreen interface 308, a network interface 310, a memory 312, and operating system 314, a mass storage 316 and an GPS 318, with each communicating across a local data bus 320. Additionally, mobile device 102 incorporates a system for gifting 120, which is depicted as member 332 and desired items 334 although the location of information 332 and 334 could vary.

The processing device 302 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device. Note that although depicted separately in FIG. 3, the system and method for enabling commercial transactions on behalf of members joined in a social network 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the mobile device 102 will comprise GPS 318 or other means to determine the location of the mobile device 102.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

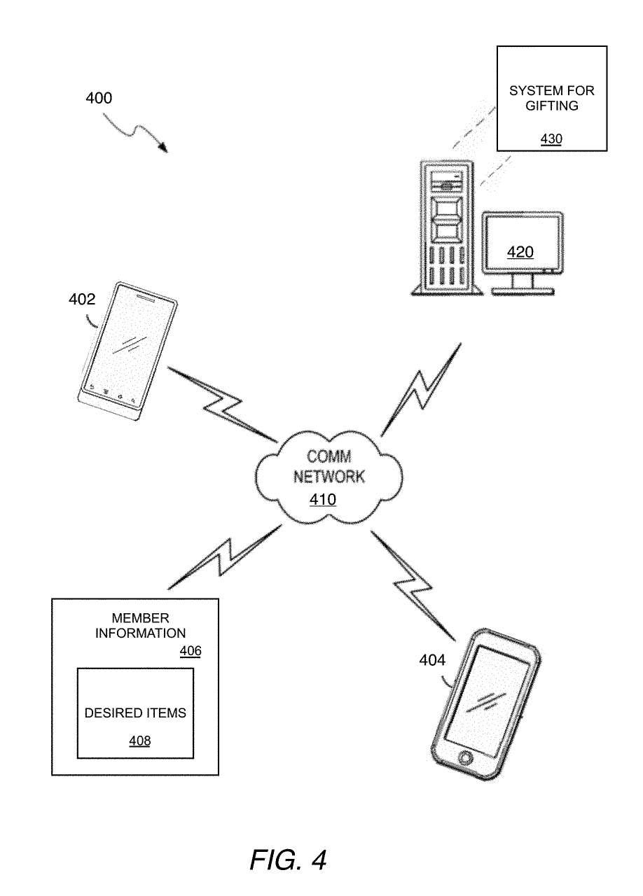

FIG. 4 is illustrative of an alternative networked environment in which another exemplary embodiment of a system for enabling commercial transactions on behalf of members joined in a social network is implemented. As shown in FIG. 4, system 400 comprises a plurality of mobile devices. By way of example, and not limitation, two mobile devices 402 and 404 are shown communicatively coupled via a communication network 410. Each of the mobile devices may be embodied as a mobile computing device such as, for example and without limitation, a smartphone that incorporates cellular telephone functionality. Notably, the communications network can use one or more of various communications types such as, for example and without limitation, cellular and Wi-Fi communications.

Users of mobile devices 402 and 404 may use their devices to become members of a gifting network that enables them to interact with each other using their mobile devices 402 and 404 and exchange information pertinent to gifts and items desired by each other member 408, or limited members as the case may be, in the gifting network. In this exemplary embodiment, the gifting network is facilitated by a web site that is hosted by network server 420. As such, server 420 facilitates interaction among an inclusive network of members, as may be established by the members themselves. For the purpose of the example presented in FIG. 4, the group of members includes the users of mobile devices 402 and 404.

Additionally, server 420 implements the system for enabling commercial transactions on behalf of members joined in a social network, or simply system for gifting, and facilitates sharing information related to desired items amongst members of the gifting network. Specifically, the server 420 may implement the steps outlined in FIG. 2. Accordingly, member of the gifting network can access the server 420 using their mobile devices 402 and 404 can obtain information regarding other network members and their gifts with the recipient member as well as receive notifications such as text messages and push notification reminding them that a gifting occasion is approaching.

In order to facilitate the aforementioned functionality, various aspects may be performed by one or more of the mobile devices 402, 404. In one embodiment, mobile device is operative to perform, at least in part, the method depicted in the flowchart of FIG. 2, described above.

With respect to operation of system for gifting 430, system 430 is operative to perform, at least in part, the method depicted in the flowchart of FIG. 2, described above.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile device 102, 104, 106, 402 and 404. The machine code may be converted from the source code, etc. If embodied in hardware, each block may represent a circuit or a number of interconnected circuits to implement the specified logical function(s). Additionally, although the flowchart shows specific orders of execution, it is to be understood that the orders of execution may differ.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the appearance of the user interface may vary depending on particular needs of the parties involved. Additional functionality is also contemplated without departing from the invention. For instance, desired items may comprise monetary donations, and/or physical and electronic gift certificates rather than or in addition to goods. Incentives, such as discounts, may be provided to prospective members of the gifting network, and direct access to centralizing listings of members' desired items as displayed by the system may be provided from individual sellers' own websites. Indeed, items may be added to a recipient's listing of desired items may even occur by pressing a hyper link or other electronic button available on a seller's webpage. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method and apparatus for enabling commercial transactions on behalf of members joined in a social network with which that terminology is associated. In general, the terms used in the following claims should not be constructed to limit the system, method and apparatus for enabling commercial transactions on behalf of members joined in a social network to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method and apparatus for enabling commercial transactions on behalf of members joined in a social network is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method and apparatus for enabling commercial transactions on behalf of members joined in a social network.

What is claimed is:

1. A method for enabling gifting among members of a social network, comprising:
receiving, at a first electronic device, recipient information corresponding a receipt location;
receiving, at the first electronic device, giver information, corresponding to members of the recipient's existing social network;
receiving, at the first electronic device, a selection of one or more desired items supplied by third party sellers and instructions to catalogue the one or more desired items according to a gifting occasion;
displaying, at a second electronic device corresponding to a member of the recipient's existing social network, a visual listing of the one or more desired items;
responsive to receiving a selection of a desired item at the second electronic device:
prompting payment for the item,
prompting delivery to the receipt location, and
indicating on the recipient's visual wish list that such item is purchased.

2. The method of claim 1, further comprising, after a predetermined amount of time, removing purchased items from the recipient's visual wish list.

3. The method of claim 1, wherein the receipt location is chosen from the recipient's shipping address and bank account.

4. The method of claim 1, further comprising receiving, at the first electronic device, receiving a date corresponding to a gifting occasion and, at the second electronic device, prompting members of the recipient's existing social network to view the visual listing of the one or more items within a predetermined amount of time from the date.

5. A system for enabling commercial transactions on behalf of members joined in a social network, comprising:
an electronic device operative to:
receive recipient information corresponding to a receipt location;
receive giver information corresponding to members of the recipient's existing social network;
receive a selection of one or more desired items supplied by third party sellers and instructions to catalogue the one or more desired items according to a gifting occasion;
display a visual listing of the one or more desired items;
receive a selection of a desired item;
prompt payment for the item,
prompt delivery to the receipt location, and
indicate on the visual listing that such item is purchased.

6. The system of claim 5, further comprising an electronic device operative to remove purchased items from the visual listing.

7. The system of claim 5, further comprising an electronic device operative to receive a date corresponding to a gifting occasion and, at the second electronic device, prompting members of the recipient's existing social network to view the visual listing of the one or more items within a predetermined amount of time from the date.

8. A non-transitory, tangible computer-readable medium having stored thereon computer-executable instructions, which, when executed by a computer processor, enable performance of the method comprising:
receiving, at a first electronic device, recipient information corresponding a receipt location;
receiving, at the first electronic device, giver information, corresponding to members of the recipient's existing social network;
receiving, at the first electronic device, a selection of one or more desired items and instructions to catalogue the one or more desired items according to a gifting occasion;
displaying, at a second electronic device corresponding to a member of the recipient's existing social network, a visual listing of the one or more desired items;
responsive to receiving a selection of a desired item at the second electronic device:
prompting payment for the item,
prompting delivery to the receipt location, and
indicating on the recipient's visual wish list that such item is purchased.
